(19) United States
(12) Patent Application Publication
(10) Pub. No.: US 2025/0114975 A1
(43) Pub. Date: Apr. 10, 2025

(54) CONTOURED CUTTING SEGMENT FOR A CHAINSAW CHAIN

(71) Applicant: Oregon Tool, Inc., Portland, OR (US)

(72) Inventors: Edgar A. Dallas, Beaverton, OR (US); Isaac Safdie-Miller, Portland, OR (US); Antony Nguyen, Happy Valley, OR (US)

(73) Assignee: Oregon Tool, Inc., Portland, OR (US)

(21) Appl. No.: 18/906,058

(22) Filed: Oct. 3, 2024

Related U.S. Application Data
(60) Provisional application No. 63/587,807, filed on Oct. 4, 2023.

(51) Int. Cl. B28D 1/08

(52) U.S. Cl. CPC B28D 1/082

(57) ABSTRACT

A saw chain includes a first tie strap, a first drive link coupled to the first tie strap, a second tie strap coupled to the first drive link, a second drive link coupled to the second tie strap, a third tie strap coupled to the second drive link, a first contoured cutting segment coupled to the first tie strap and having a first asymmetric profile, and a second contoured cutting segment coupled to the third tie strap and having a second asymmetric profile. The first contoured cutting segment and the second contoured cutting segment are oriented such that the first asymmetric profile is symmetric with the second asymmetric profile across the second drive link.

### CROSS-REFERENCE TO RELATED PATENT APPLICATIONS

This application claims priority to U.S. Provisional Patent Application No. 63/587,807, filed on Oct. 4, 2023, which is incorporated herein by reference in its entirety.

### BACKGROUND

The present disclosure relates generally to chain saws, in particular to saw chains for use with concrete and aggregate-cutting chains. Contoured cutting segments included in such saw chains can include abrasive cutting particles such as diamond particles distributed within a 3-dimensional matrix. A typical matrix used for supporting the abrasive cutting particles used for concrete cutting is composed of hard abrasive resistant, metal material. For the abrasive cutting particles such as diamonds provided in the matrix to effectively cut or grind the concrete, the points of the diamond particles within the matrix surface level must be exposed during initial cutting as the matrix material is ground off (referred to in the art as “self-dressing”). Due to the need for self-dressing, segments are less efficient at cutting concrete when a chain is first installed because the abrasive diamond points are not yet exposed. Therefore, a user may initially have difficulty cutting concrete after a new chain is installed.

### SUMMARY

At least one embodiment relates a saw chain. The saw chain includes a first tie strap, a first drive link coupled to the first tie strap, a second tie strap coupled to the first drive link, a second drive link coupled to the second tie strap, a third tie strap coupled to the second drive link, a first contoured cutting segment coupled to the first tie strap and having a first asymmetric profile, and a second contoured cutting segment coupled to the third tie strap and having a second asymmetric profile. The first contoured cutting segment and the second contoured cutting segment are oriented such that the first asymmetric profile is symmetric with the second asymmetric profile across the second drive link.

Another embodiment relates to a chain saw including a saw chain. The saw chain includes a first tie strap and a contoured cutting segment coupled to the first tie strap. The contoured cutting segment includes a first asymmetric tooth and a second asymmetric tooth. The second asymmetric tooth is oriented such that the second asymmetric tooth is symmetric with the first asymmetric tooth across a center of the contoured cutting segment.

Another embodiment relates to a saw chain including a first tie strap, a first drive link coupled to the first tie strap, a second tie strap coupled to the first drive link, a second drive link coupled to the second tie strap, a third tie strap coupled to the second drive link, a first contoured cutting segment coupled to the first tie strap and a second contoured cutting segment coupled to the third tie strap. The first contoured cutting segment has a first plurality of asymmetric teeth. The second contoured cutting segment has a second plurality of asymmetric teeth. The second plurality of asymmetric teeth are symmetric with the first plurality of asymmetric teeth across the second tie strap.

This summary is illustrative only and is not intended to be in any way limiting.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a chain saw having a saw chain with contoured cutting segments, according to some embodiments.

FIG. 2 is a perspective view of a portion of the saw chain of FIG. 1, according to some embodiments.

FIG. 3 is a side view of the saw chain of FIG. 2, according to some embodiments.

FIG. 4 is another side view of the saw chain of FIG. 2, according to some embodiments.

FIG. 5 is a top view of the saw chain of FIG. 2, according to some embodiments.

FIG. 6 is a bottom view of the saw chain of FIG. 2, according to some embodiments.

FIG. 7 is a front end view of the saw chain of FIG. 2, according to some embodiments.

FIG. 8 is a back end view of the saw chain of FIG. 2, according to some embodiments.

FIG. 9 is a perspective view of a contoured cutting segment of the saw chain of FIG. 2, according to some embodiments.

FIG. 10 is a side view of the contoured cutting segment of FIG. 9, according to some embodiments.

FIG. 11 is a perspective view of a portion of the saw chain of FIG. 1, according to some embodiments.

FIG. 12 is a side view of the saw chain of FIG. 11, according to some embodiments.

FIG. 13 is another side view of the saw chain of FIG. 11, according to some embodiments.

FIG. 14 is a top view of the saw chain of FIG. 11, according to some embodiments.

FIG. 15 is a bottom view of the saw chain of FIG. 11, according to some embodiments.

FIG. 16 is a front end view of the saw chain of FIG. 11, according to some embodiments.

FIG. 17 is a back end view of the saw chain of FIG. 11, according to some embodiments.

FIG. 18 is a perspective view of a contoured cutting segment of the saw chain FIG. 11, according to some embodiments.

FIG. 19 is a side view of a contoured cutting segment of the saw chain FIG. 11, according to some embodiments.

FIG. 20 is a top view of a contoured cutting segment of the saw chain FIG. 11, according to some embodiments.

FIG. 21 is a perspective view of a contoured cutting segment of the saw chain of FIG. 1, according to some embodiments.

FIG. 22 is a side view of a contoured cutting segment of the saw chain FIG. 21, according to some embodiments.

FIG. 23 is a top view of a contoured cutting segment of the saw chain FIG. 21, according to some embodiments.

### DETAILED DESCRIPTION

Referring generally to the figures, views of a concrete-cutting chain saw, saw chain for cutting concrete and other aggregate materials, and contoured cutting segments of the saw chain are shown, according to various embodiments. As described in further detail below, the teachings herein relate to a contoured cutting segment which minimizes initial surface contact with a workpiece to be cut, such as concrete, thereby increasing cutting pressures and rapidly eroding matrix material to quickly expose the cutting points of an abrasive element such as diamonds supported in the matrix. As the supporting matrix is worn away to expose the cutting points of the abrasive elements, self-dressing is achieved more quickly than for conventional designs. Each contoured cutting segment according to the teachings herein is asymmetric about a lateral axis of the contoured cutting segment. A saw chain can then be provided with such contoured cutting segments arranged in alternating orientations such that a line of symmetry is created between the neighboring contoured cutting segments on the chain (e.g., between cutting links), which may provide performance advantages as well as allowing the user to install the chain for rotation in either direction. The teachings herein can thereby support user-friendly installation and reduce the amount of time and energy spent self-dressing, such that the saw chain can quickly be put into full use in concrete cutting and/or other applications.

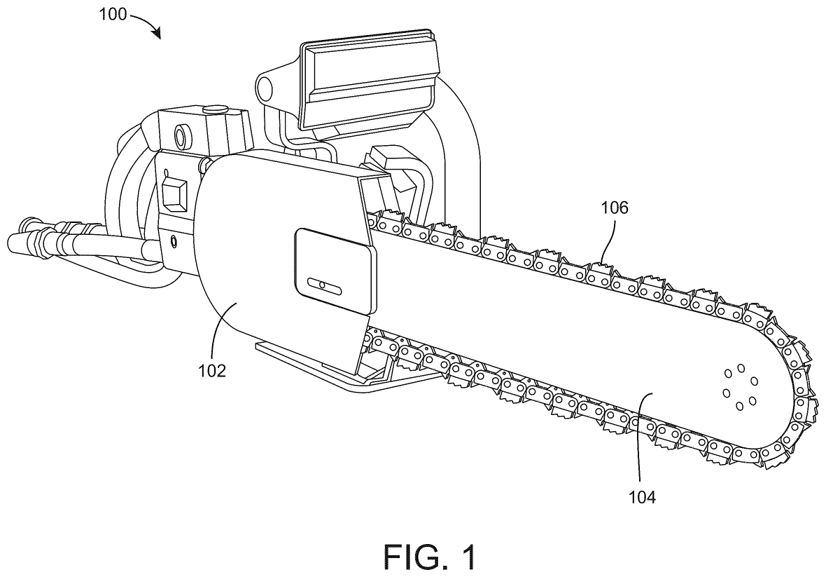

Referring now to FIG. 1, a chain saw 100 is shown, according to some embodiments. The chain saw 100 as shown in FIG. 1 is configured for cutting concrete and other similar materials (e.g., asphalt, aggregate, etc.). The chain saw 100 includes a body 102, a guide bar 104 coupled and extending from the body 102, and a saw chain 106 coupled to the guide bar 104 and extending along a periphery of the guide bar 104 (e.g., in a closed loop). The body 102 includes a motor (e.g., combustion engine, electric motor) operable to rotate the saw chain 106 around the periphery of the guide bar 104, such that the saw chain 106 rotates around the guide bar 104 during operation of the chain saw 100. The saw chain 106 includes contoured cutting segments or links with sharp or rough portions, etc. (e.g., as described in detail below) such that, when driven to rotate around the guide bar 104, the saw chain 106 can cut into, grind, etc. external objects, materials etc. The chain saw 100 can also including irrigation features for lubricating and cooling the chain and otherwise facilitating high-power cutting and grinding operations of the chain saw 100.

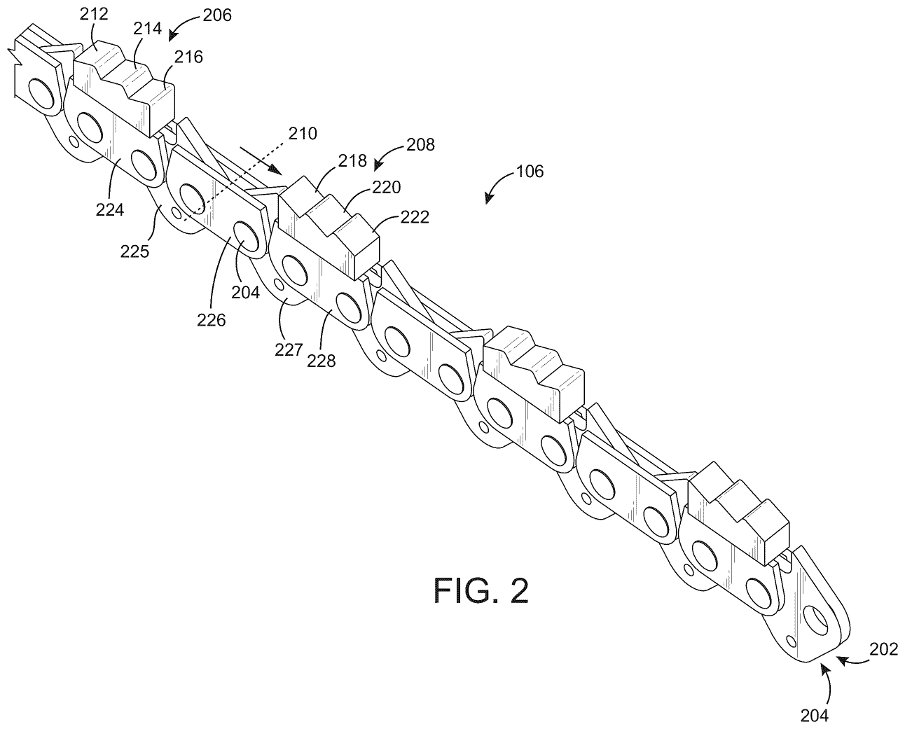

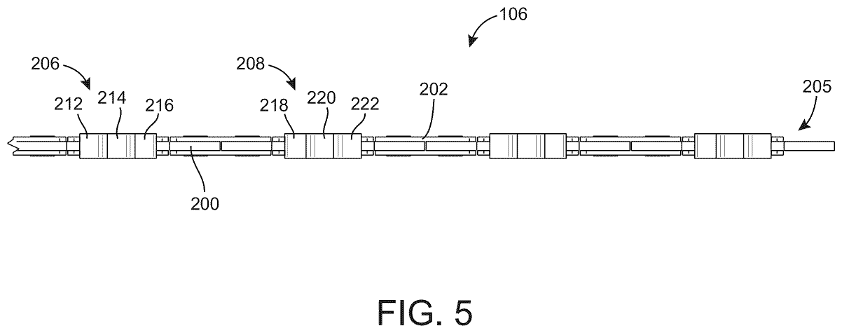

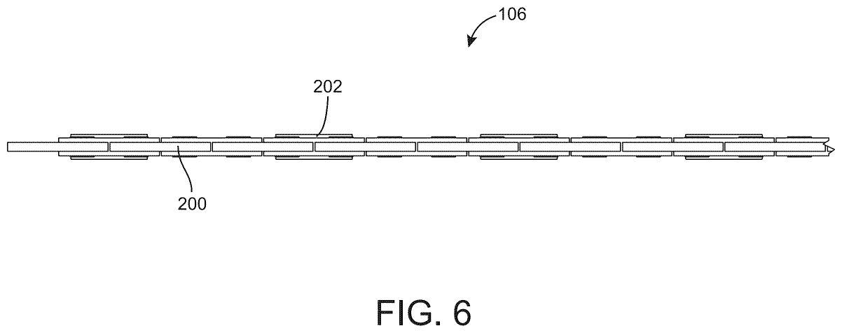

Referring now to FIG. 2 through FIG. 8, different perspectives of the saw chain 106 are shown, according to some embodiments. The saw chain 106 is configured to cut concrete and aggregate when used with the chain saw 100. The saw chain 106 comprises drive links 200 coupled to tie straps 202 by rivets 204. The drive links 200 include extensions from the saw chain 106 configured to slot into a groove provided on the periphery of the guide bar 104. Drive links 200 couple the saw chain 106 to this guide bar 104 and provide an interface between a motor, etc., of the chain saw 100 to enable the saw chain 106 to be driven around the guide bar 104 during operation of the chain saw 100. The drive links 200 are coupled to one another by tie straps 202 positioned on both lateral sides of the drive links 200. The tie straps 202 couple the drive links together 200 so that the saw chain 106 can be assembled into a loop. The drive links 200 and tie straps 202 are coupled by rivets 204 which act as a coupler for the different portions of the saw chain 106. As shown in the disclosed embodiment, one tie strap 202 is on either side of each drive link 200 and one rivet 204 couples each drive link 200 and tie strap 202 combination (i.e., one drive link 200 and two tie straps 202, such that each drive link 200 is coupled to two rivets 204, and each tie strap 202 is coupled to two rivets 204). In particular, as shown, the saw chain 106 includes a first tie strap 224 coupled to a first drive link 225 by a rivet 204, a second tie strap 226 coupled to the first drive link 225 by a rivet 204, a second drive link 227 coupled to a second tie strap 226 by a rivet 204, and a third tie strap 228 coupled to the second drive link 227 by a rivet.

The saw chain 106 also includes contoured cutting segments 205 which include a first segment 206 coupled to the first tie strap 224 and a second segment 208 coupled to the third tie strap 228. The segments 205 are coupled to the tie straps 202 and positioned on a top side (e.g., away from the guide bar 104 when installed as in FIG. 1) of the tie straps 202. As shown, the segments 205 are coupled to every other tie strap 202 through a fastening process such as welding, although in other embodiments the segments 205 may be coupled by other means (e.g., sintering, adhesive, etc.), and the pattern of distribution of the segments 205 along the tie straps 202 and drive links 200 may differ depending upon the cutting conditions and needs. For example, in some embodiments consecutive tie straps 202 can have segments 205 coupled thereto. In other embodiments, every third, fourth, fifth, etc. tie strap 202 has a segment 205 coupled thereto (with other tie straps 202 lacking segments 205). In some embodiments, the segments 205 are constructed of a hard abrasive resistant material, one example being metal matrix composed of cobalt. Diamond particles are distributed within this 3-dimensional metal matrix, for example roughly equally throughout the matrix. During manufacturing, a top surface of the segments 205 may be formed in a manner so as to be primarily metal material, however, diamond particles below the matrix surface level must be exposed for the segments 205 to cut effectively, as the diamond particles provide friction, abrasion, scraping, grinding, etc. and are typically harder than the concrete or other material to be cut by the saw chain 106. Efficient exposure of such diamond particles via initial use of the saw chain (i.e., via self-dressing) is enabled by the segments 205, as described in further detail below.

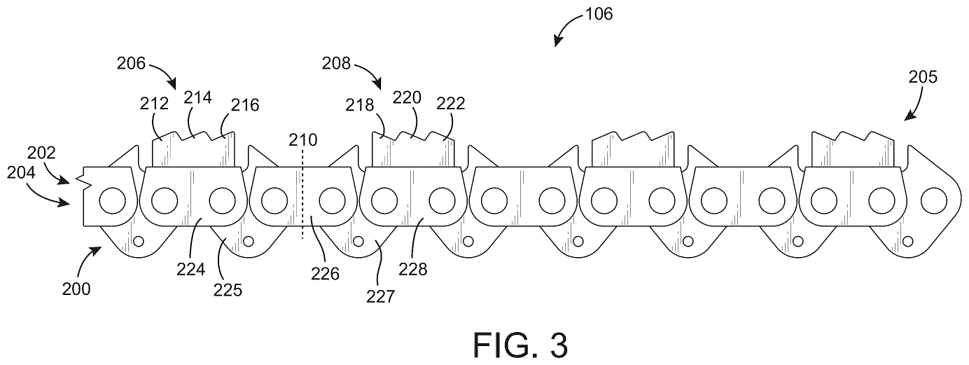

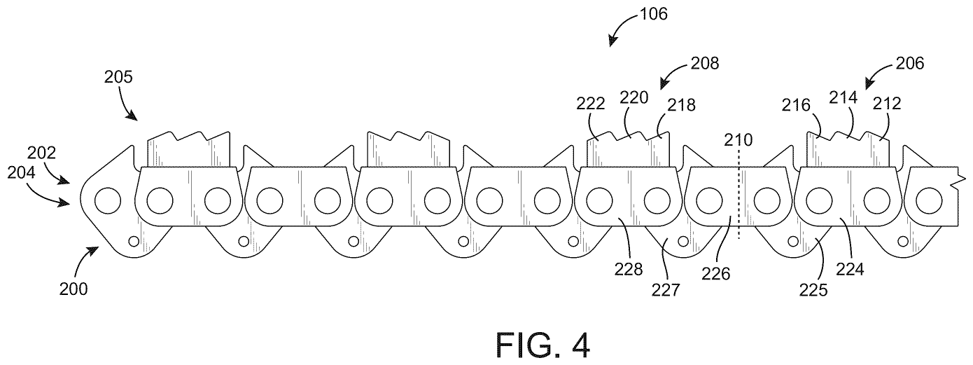

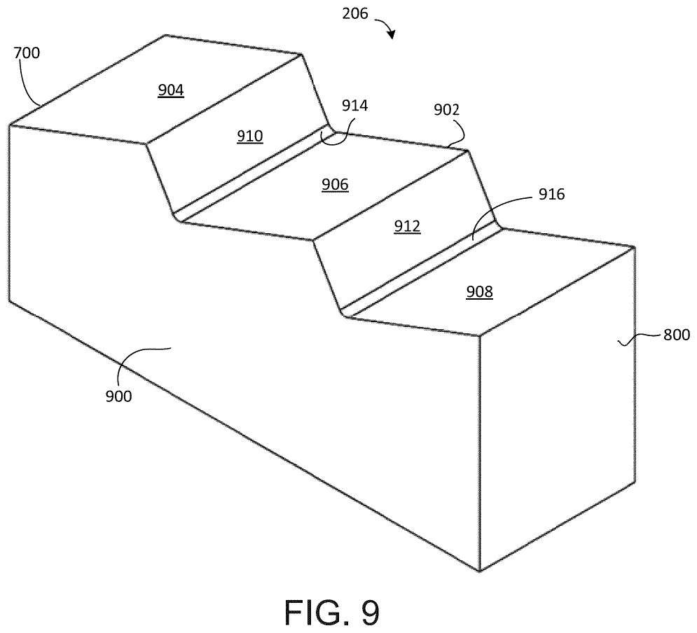

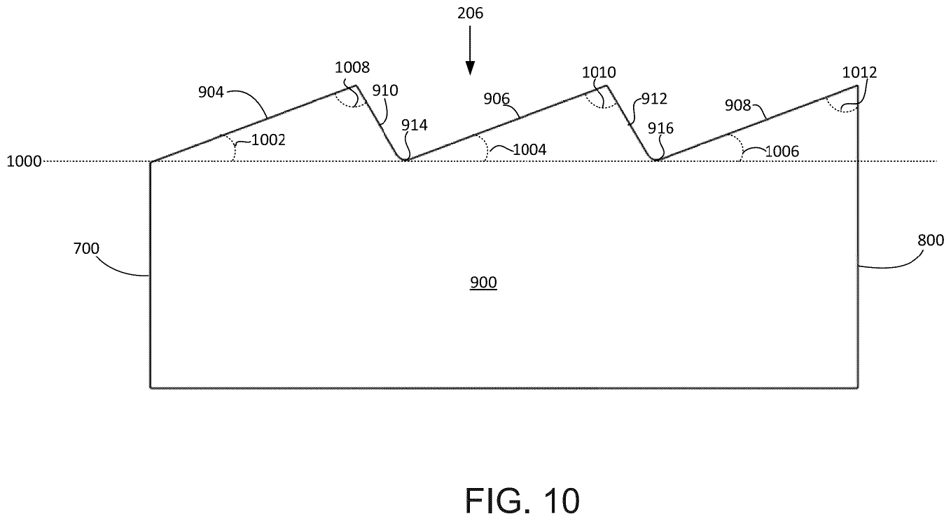

The contoured cutting segments 205 are shown as including teeth, with each segment 205 including multiple teeth. Specifically, as shown, the first segment 206 includes a first tooth 212, a second tooth 214, and a third tooth 216 defining a top surface of the first segment 206 and arranged in series with the second tooth 214 between the first tooth 212 and the third tooth 216. The geometry of the first tooth 212, the second tooth 214, and the third tooth 216 according to various embodiments is described in further detail below with reference to FIGS. 9-10. Similarly, the second segment 208 is shown as including a fourth tooth 218, a fifth tooth 220, and a sixth tooth 222 defining a top surface of the second segment 208 and arranged in series with the fifth tooth 220 between the fourth tooth 218 and the sixth tooth 222. The geometry of the fourth tooth 218, a fifth tooth 220, and a sixth tooth 222 according to various embodiments is described in further detail below with references to FIGS. 9-11. The various teeth are asymmetric from the side views of FIGS. 3-4, such that each segment 205 is also asymmetric from the side view of FIGS. 3-4. As shown, the first segment 206 contains the same number of teeth as the second segment 208, although in other embodiments segments 205 may contain different numbers of teeth than as shown (e.g., two teeth, four teeth, etc.)

The segments 205 are configured to facilitate self-dressing. In particular, the segments 205 are configured so as to minimize the initial surface contact between the segments and the concrete, which increases cutting pressures and rapidly erodes the matrix, without compromising structural integrity of the segments 205. Thus, diamond points in the segments 205 are more quickly exposed for cutting as compared to other possible configurations for diamond segments of concrete cutting chains, especially in view of the particular arrangement of the teeth described in further detail below.

The segments 205 are arranged in a pattern along the saw chain 106. The second segment 208 is oriented relative to the first segment 206 such that it appears as a reflection of the first segment 206 (e.g., oriented in an opposite axial direction than the first segment 206). To elaborate, FIGS. 2-6 show a first tie strap 224, a second tie strap 226, and a third tie strap 228 coupled in series, with the second tie strap 226 between the first tie strap 224 and the third tic strap 228. The center of the second tie strap 226 defines a vertical line of symmetry 210 (i.e., in a plane of the saw chain 106 and orthogonal to a cutting direction of the saw chain, line of reflection, etc.). The first segment 206, which is coupled to the first tie strap 224, is oriented so as to appear as a reflection of the second segment 208 (which is coupled to the third tie strap 228), i.e., such that the saw chain 106 is symmetric across the line of symmetry 210. The pattern repeats for the entire length of the saw chain 106, so that each contoured cutting segment 205 is oriented in an opposite direction than both of its neighboring segments 205.

As shown, as a result of such symmetry, the teeth also appear as if reflected over the line of reflection 210. For example, the first tooth 212 of the first segment 206 and the fourth tooth 218 of the second segment 208 are symmetric over the line of reflection 210, the second tooth 214 of the first segment 206 and the fifth tooth 220 are symmetric over the line of reflection, and the third tooth 216 of the first segment 206 and the sixth tooth 222 are symmetric over the line of reflection 210.

Providing the segments 205 in such a pattern (e.g., in alternating directions) enables the saw chain 106 to be used as a bi-directional cutting chain, i.e., to cut concrete whether the cutting chain is driven in a first longitudinal direction of the chain or an opposite, second longitudinal direction of the chain. Advantageously, the saw chain 106 can be coupled to the guide bar 104 in either direction, reducing user installation error of the saw chain 106 and otherwise improving usability of the saw chain 106. In other embodiments, various other patterns of orientations of the segments 205 may be used and/or the segments 205 may be provided in the same orientation.

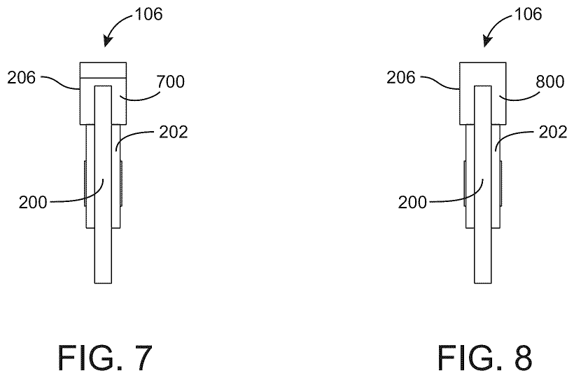

As visible from the end views of FIGS. 7-8, the first segment 206 includes a first end 700 and second end 800 opposite the first end 700. As shown, the first end 700 and the second end 800 are roughly rectangular (e.g., square), but the shape can differ depending on the embodiment (e.g., curved, oblong, triangular, etc.). As shown, the second end 800 has a larger surface area than the first end 700.

As shown, the first segment 206 also includes a first side 900 and a second side 902 opposite the first side 900, with the first side and the second side 902 extending from the first end 700 to the second end 800. The first side 900 is perpendicular to the first end 700 and second end 800, and the second side 902 is perpendicular to the first end 700 and the second end 800, while the first side 900 is parallel to the second side 902. The first segment 206 may be a substantially solid block bounded by the first side 900, the second side 902, first end 700, and second end 800.

As shown, the first side 900 and second side 902 have lengths of approximately 0.68 inches (for example between 0.60 and 0.80 inches), and the first end 700 and second end 800 have lengths of approximately 0.225 inches (for example between 0.20 and 0.30 inches). These lengths can be smaller or larger in other embodiments depending on the size of the chain saw 100, saw chain 106, material being cut, etc.

Referring now to FIGS. 9-10, close-up views of the first contoured cutting segment 206 are shown, according to some embodiments. The first segment 206 includes a first ramp 904 which extends from the first end 700 to a first face 910 of the first segment 206. The first face 910 is angled downward relative to the first ramp 904, such that the first ramp 904 and the first face 910 combine to form the first tooth 212. The first segment 206 also includes a second ramp 906. The second ramp 906 extends from a transition or corner 914 between the first face 910 and the second ramp 906 to the second face 912 of the first segment 206. The second face 912 is angled relative to the second ramp 906, such that the second ramp 906 and the second face 912 combine to form the second tooth 214. The first segment 206 also includes a third ramp 908. The third ramp 908 extends from a transition or corner 916 between the second face 912 and the third ramp 908 to the second end 800. A surface area of the first ramp 904 is shown as being larger than a surface area of the first face 910, while a surface area of the second ramp 906 is shown as being larger than surface area of the second face 912 (e.g., approximately double the surface area), and surface area of the third ramp 908 is substantially similar to the first ramp 904 and the second ramp 906. The first segment is thereby provided with an asymmetric profile.

As illustrated in FIG. 10, the first ramp 904 is oriented relative to a tooth base plane 1000 such that a first ramp angle 1002 is defined between the tooth base plane 1000 and the first ramp 904 (internal to the first segment 206). The second ramp 906 is oriented relative to the tooth base plane 1000 such that a second ramp angle 1004 is defined between the tooth base plane 1000 and the second ramp 906. The third ramp 908 is oriented relative to the tooth base plane 1000 such that a third ramp angle 1006 is defined between the tooth base plane 1000 and the third ramp 908. As shown, the ramp angles 1002, 1004, 1006 are about 20 degrees and may be substantially equal to one another such that the ramps 904, 906, 908 are substantially parallel to each other. Other embodiments may include different ramp angles 1002, 1004, 1006, ranging anywhere from 10 degrees to 35 degrees, for example substantially the same value for each ramp angle 1002, 1004, 1006 or different values for different ramp angles 1002, 1004, 1006. Similarly, other embodiments may include ramps of different lengths which could generate different ramp angles.

Each transition or corner 914, 916 is shown as a curve with a radius. As shown, both the first corner 914 and second corner 916 have substantially the same radius, however, in other embodiments, the corners 914, 916 may have different radii for example, the corners 914, 916 have a radius between 0.05 inches to 0.25 inches, for example 0.01 inches.

The first face 910 is oriented relative to the first ramp 904 such that a first face angle 1008 is defined between the first ramp 904 and the first face 910 (internal to the first segment 206). The second face 912 is oriented relative to the second ramp 906 such that a second face angle 1010 is defined between the second ramp 906 and the second face 912 (internal to the first segment 206). The second end 800 is oriented relative to the third ramp 908 such that a third face angle 1012 is defined between the third ramp 908 and second end (internal to the first segment 206). The first face angle 1008 and the second face angle 1010 are acute angles up to approximately 90 degrees, and are shown as being substantially equal to one another (but may differ from one another in other embodiments). In some embodiments the first face angle 1008 and the second face angle 1010 have values between 70 degrees and 90 degrees.

The third face angle 1012 is shown as differing from (in particular, as smaller than) the first face angle 1008 and the second face angle 1010 since the third ramp 908 is adjacent to the second end 800 instead of another face. In other embodiments, the third ramp 908 may be adjacent to another face which extends from the third ramp 908 to the second end 800. In the embodiments shown, the third face angle 1012 is approximately 20 degrees, although in various embodiments the third face angle 1012 may range from 10 degrees to 35 degrees.

Advantageously, the layout of the faces 910, 912, corners 914, 916 and ramps 904, 906, 908 minimizes initial surface contact between the contoured cutting segment and the work piece while maintaining structural integrity of the first segment 206 in a manner that results in quicker self-dressing to expose diamond points of the first segment 206 more quickly (as compared to other designs) thereby enabling efficient first-use of the saw chain 106. The second segment 208 and/or various other segments 205 of the saw chain 106 can be configured substantially the same as the first segment 206. The saw chain 106 is thereby provided with multiple contoured cutted segments 205, each having an asymmetric profile as described for the first segment 206 and arranged as described above and shown in the drawings. In experimental testing of out-of-the box performance, a saw chain 106 according to the teachings herein was able to cut 33.6% more concrete during a first and second cut in initial use of the saw chain 106 as compared to initial use of a conventional design and 58.9% more concrete through a first, second and third cut in initial use of the saw chain 106 as compared the conventional design, thereby exhibiting improved self-dressing and performance on initial use.

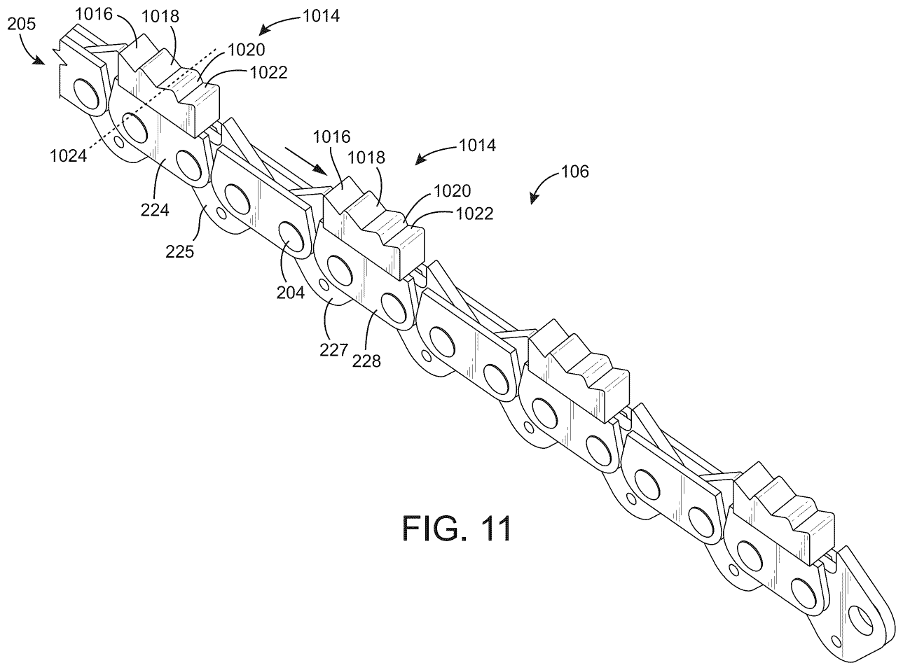

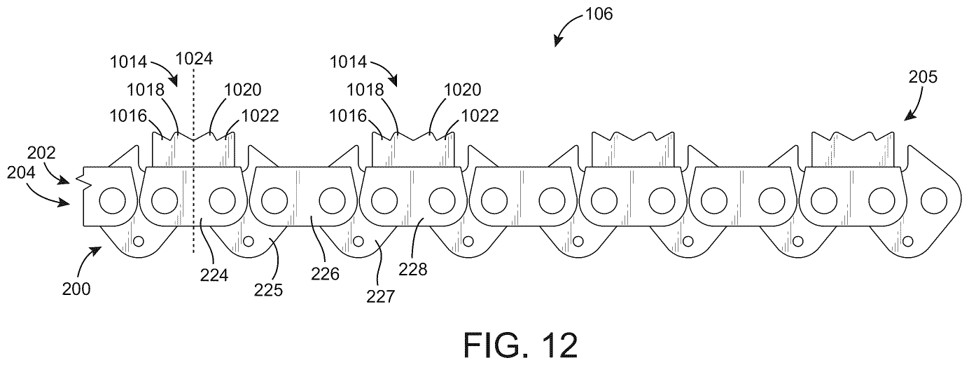

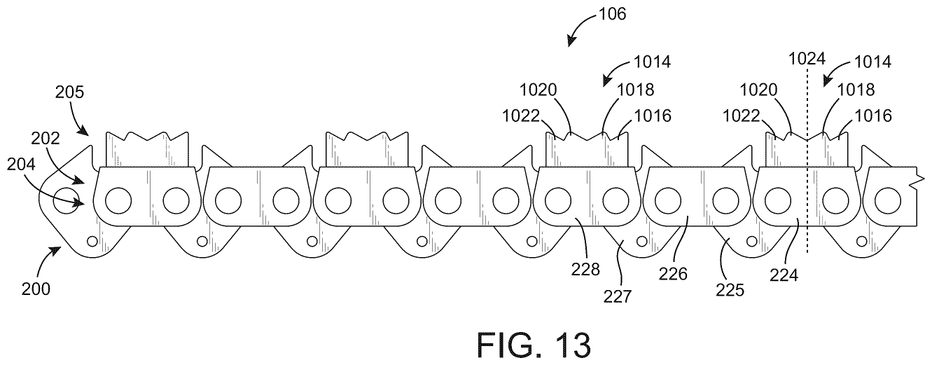

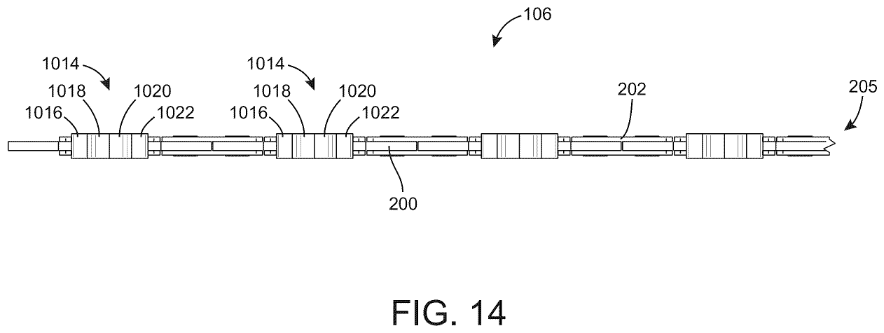

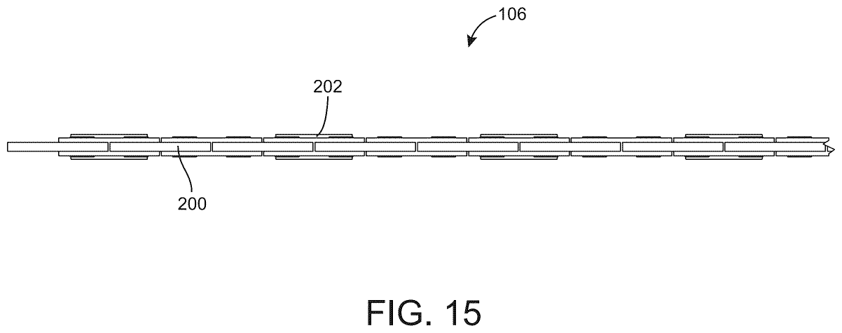

Referring now to FIG. 11 through FIG. 17, different perspectives of the saw chain 106 are shown, according to some embodiments. In this embodiment, a segment 1014 includes a first tooth 1016, a second tooth 1018, a third tooth 1020, and a fourth tooth 1022. The first tooth 1016 and the fourth tooth 1022 are symmetric from the side views of FIGS. 12-13 and the second tooth 1018 and the third tooth 1020 are symmetric from the side views of FIGS. 12-13, such that each segment 1014 is also symmetric from the side views of FIGS. 12-13. The first tooth 1016 is asymmetric with the second tooth 1018, and the third tooth 1020 is asymmetric with the fourth tooth 1022. As shown, each segment 1014 contains the same number of teeth, although in other embodiments each segment 1014 may contain different numbers of teeth than shown (e.g., two teeth, six teeth, etc.).

The center of the segment 1014 defines a vertical line of symmetry 1024 (i.e., in a plane of the saw chain 106 and orthogonal to a cutting direction of the saw chain). The first tooth 1016 is oriented so as to appear a reflection of fourth tooth 1022 and the second tooth 1018 is oriented so as to appear a reflection of the third tooth 1020, i.e. such that the segment 1014 is symmetric across the line of symmetry 1024. As in the embodiment of FIGS. 2-10, each segment 1014 is symmetric with the next segment 1014 along the saw chain 106 about a line of symmetry through the drive link 220 between the two segments 1014. That is, the first tooth 1016 is symmetric with the fourth tooth 1022 on the neighboring segment 1014, the second tooth 1018 is symmetric with the third tooth 1020 on the neighboring segment 1014, the third tooth 1020 is symmetric with the second tooth 1018 on the neighboring segment 1014, and the fourth tooth 1022 is symmetric with the first tooth 1016 on the neighboring segment about the drive link 220 between the two segments.

Providing the segment 1014 in such a pattern (e.g., providing multiple asymmetric teeth on a single segment to create a segment symmetric about a line of symmetry 1024 through the segment 1014) enables the saw chain 106 to be used as a bi-directional cutting chain. Advantageously, this embodiment integrates the multiple asymmetric segments of FIGS. 2 through 8 into a single symmetric segment, which may reduce manufacturing time when assembling the chain.

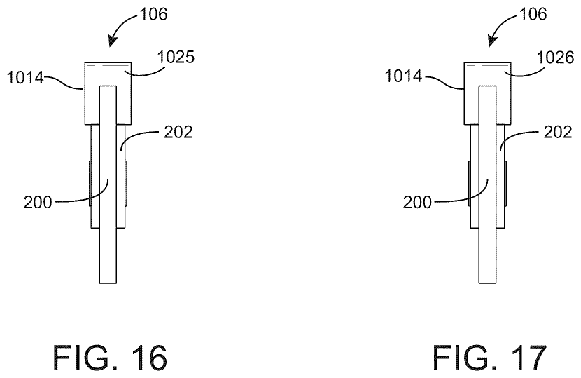

As visible from the end views of FIGS. 16-17, the segment 1014 includes a first end 1025 and a second end 1026 opposite the first end 1025. As shown, the first end 1025 and the second end 1026 are substantially rectangular (e.g., square), but the shape can differ depending on the embodiment (e.g., curved, oblong, triangular, etc.). As shown, the first end 1025 has a surface area equal to the surface area of the second end 1026.

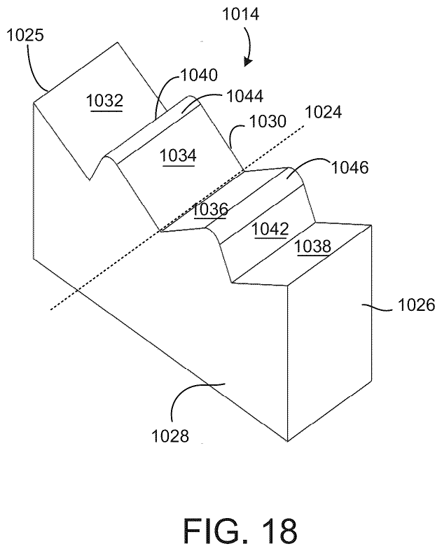

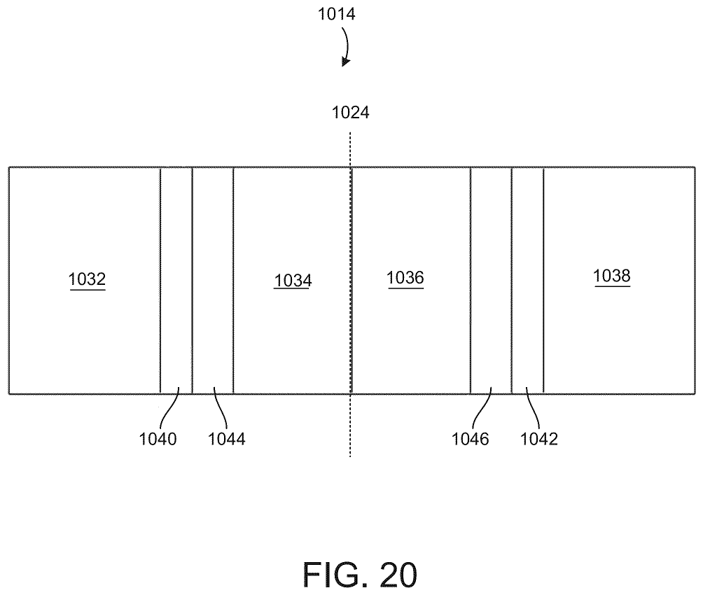

Referring now to FIGS. 18-20, close-up views of the segment 1014 are shown, according to some embodiments. The segment 1014 also includes a first side 1028 and a second side 1030 opposite the first side 1028, with the first side 1028 and the second side 1030 extending from the first end 1025 to the second end 1026. The first side 1028 is perpendicular to the first end 1025 and second end 1026, and the second side 1030 is perpendicular to the first end 1025 and the second end 1026, while the first side 1028 is parallel to the second side 1030. The segment 1014 may be a substantially solid block bounded by the first side 1028, the second side 1030, the first end 1025, and the second end 1026.

The segment 1014 includes a first ramp 1032 which extends from the first end 1025 to a first face 1040 of the segment 1014. The first ramp 1032 is angled relative to the first end 1025 to form the first tooth 1016. The first face 1040 is angled upward relative to the first ramp 1032. The segment 1014 also includes a second ramp 1034. The second ramp 1034 extends from a transition or corner 1044 between the first face 1040 and the second ramp 1034. The second ramp 1034 is angled relative to the first face 1040, such that the first face 1040 and the second ramp 1034 form the second tooth 1018. The segment 1014 also includes a third ramp 1036. The third ramp 1036 extends from the second ramp 1034, as shown from a point intersected by line of symmetry 1024. The third ramp 1036 is angled upward relative to the second ramp 1034. The segment 1014 also includes a second face 1042. The second face 1042 extends from a transition or corner 1046 between the third ramp 1036 and the second face 1042. The second face 1042 is angled relative to the third ramp 1036, such that the second face 1042 and the third ramp 1036 form the third tooth 1020. The segment 1014 also includes a fourth ramp 1038. The fourth ramp 1038 extends from the second face 1042 to the second end 1026. The fourth ramp 1038 is angled upward relative to the second face 1042. The fourth ramp 1038 is angled relative to the second end 1026 such that the fourth ramp 1038 and the second end 1026 form the fourth tooth 1022. A surface area of the first ramp 1032 is shown as being larger than a surface area of the second ramp 1034, and a surface area of the second ramp 1034 is shown as being larger than a surface area of the first face 1040. The surface area of the first ramp 1032 is shown as being equal to a surface area of the fourth ramp 1038, the surface area of the second ramp 1034 is shown as being equal to a surface area of the third ramp 1036, and the surface area of the first face 1040 is shown as being equal to a surface area of the second face 1042. The segment 1014 is thereby provided with a symmetric profile.

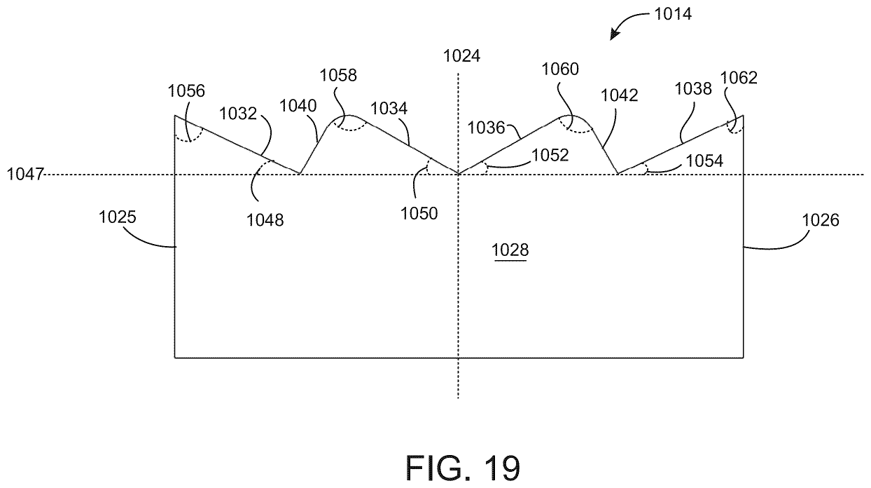

As illustrated in FIG. 19, the first ramp 1032 is oriented relative to a tooth base plane 1047 such that a first ramp angle 1048 is defined between the tooth base plane 1047 and the first ramp 1032 (internal to the segment 1014). The second ramp 1034 is oriented relative to the tooth base plane 1047 such that a second ramp angle 1050 is defined between the tooth base plane 1047 and the second ramp 1034 (internal to the segment 1014). The third ramp 1036 is oriented relative to the tooth base plane 1047 such that a third ramp angle 1052 is defined between the tooth base plane 1047 and the third ramp 1036 (internal to the segment 1014). The fourth ramp 1038 is oriented relative to the tooth base plane 1047 such that a fourth ramp angle 1054 is defined between the tooth base plane 1047 and the fourth ramp 1038 (internal to the segment 1014). As shown, ramp angles 1048, 1050, 1052, and 1054 are about 20 degrees and are substantially equal to one another such that ramps 1032 and 1034 are substantially parallel to each other and ramps 1036 and 1038 are substantially parallel to each other. Other embodiments may include different ramp angles 1048, 1050, 1052, 1054 ranging anywhere from 10 degrees to 35 degrees, for example substantially the same value for each ramp angle 1048, 1050, 1052, 1054 or different values for different ramp angles 1048, 1050, 1052, 1054. Similarly, other embodiments may include ramps of different lengths which could generate different ramp angles.

Each transition or corner 1044, 1046 is shown as a curve with a radius. As shown, both the first corner 1044 and second corner 1046 have substantially the same radius, however, in other embodiments, the corners 1044, 1046 may have different radii for example, the corners 1044, 1046 have a radius between 0.05 inches to 0.25 inches, for example approximately 0.01 inches.

The first ramp 1032 is oriented relative to the first end 1025 such that a first face angle 1056 is defined between the first ramp 1032 and the first end 1025 (internal to the segment 1014). The first face 1040 is oriented relative to the second ramp 1034 such that a second face angle 1058 is defined between the first face 1040 and the second ramp 1034 (internal to the segment 1014). The second face 1042 is oriented relative to the third ramp 1036 such that a third face angle 1060 is defined between the second face 1042 and the third ramp 1036 (internal to the segment 1014). The fourth ramp 1038 is oriented relative to the second end 1026 such that a fourth face angle 1062 is defined between the second end 1026 and the fourth ramp (internal to the segment 1014). The second face angle 1058 and the third face angle 1060 are acute angles up to approximately 90 degrees, and are shown as being substantially equal to one another (but may differ from one another in other embodiments). In some embodiments the second face angle 1058 and the third face angle 1060 have values between 60 degrees and 90 degrees.

The first face angle 1056 and the fourth face angle 1062 are shown as differing from (in particular, smaller than), the second face angle 1058 and the third face angle 1060 since the first ramp 1032 and the fourth ramp 1038 are adjacent to the first end 1025 and the second end 1026 instead of another face. The first face angle 1056 and the fourth face angle 1062 are acute angles up to approximately 90 degrees, and are shown as being substantially equal to one another (but may differ from one another in other embodiments). In some embodiments first face angle 1056 and the fourth face angle 1062 have values between 70 degrees and 90 degrees.

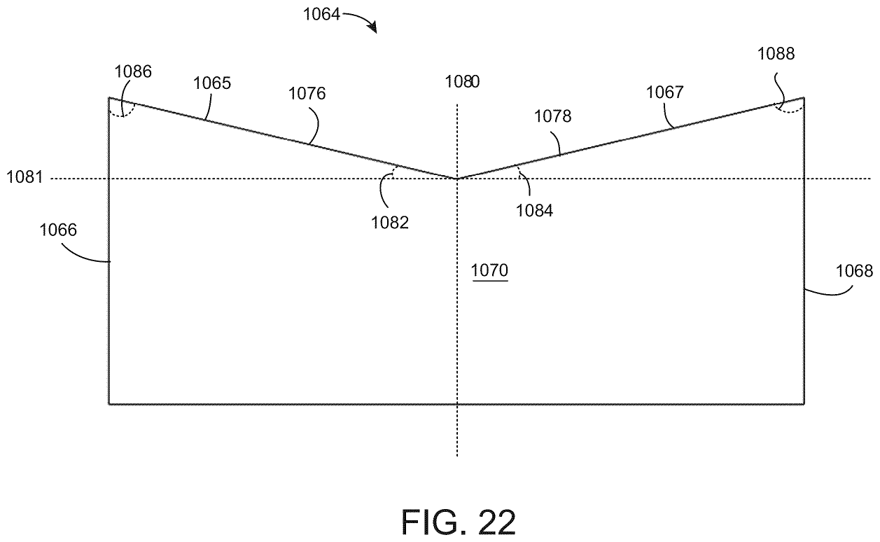

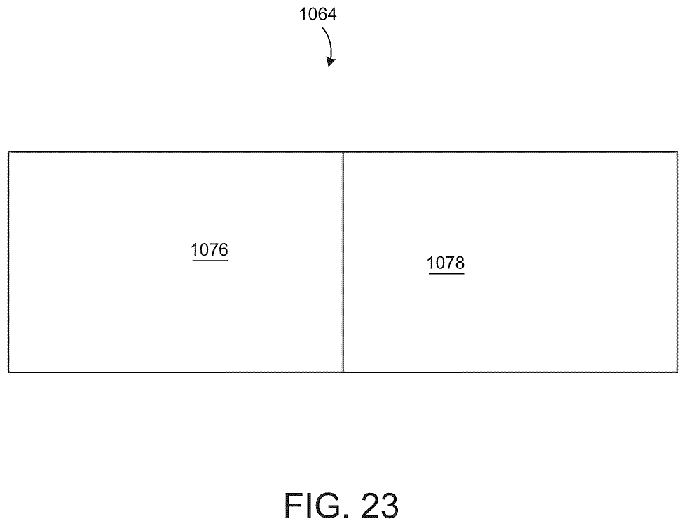

Referring now to FIG. 22 through FIG. 23, different perspectives of a segment 1064 are shown, according to some embodiments. In this embodiment, a segment 1064 includes a first tooth 1065 and a second tooth 1067. The first tooth 1065 and the second tooth 1067 are symmetric from the side view of FIG. 22 such that each segment 1064 is also symmetric from the side view of FIG. 22. The center of the segment 1064 defines a vertical line of symmetry 1080 (i.e., in a plane of the saw chain 106 and orthogonal to a cutting direction of the saw chain). The first tooth 1065 is oriented so as to appear a reflection of second tooth 1067 i.e., such that segment 1064 is symmetric across the line of symmetry 1080.

Providing the segment 1064 in such a pattern (e.g., providing teeth on a single segment to create a segment symmetric about a line of symmetry 1080 through the segment 1064) enables the saw chain 106 to be used as a bi-directional cutting chain. Advantageously, this embodiment integrates the multiple asymmetric segments of FIGS. 2 through 8 into a single symmetric segment, which may reduce manufacturing time when assembling the chain.

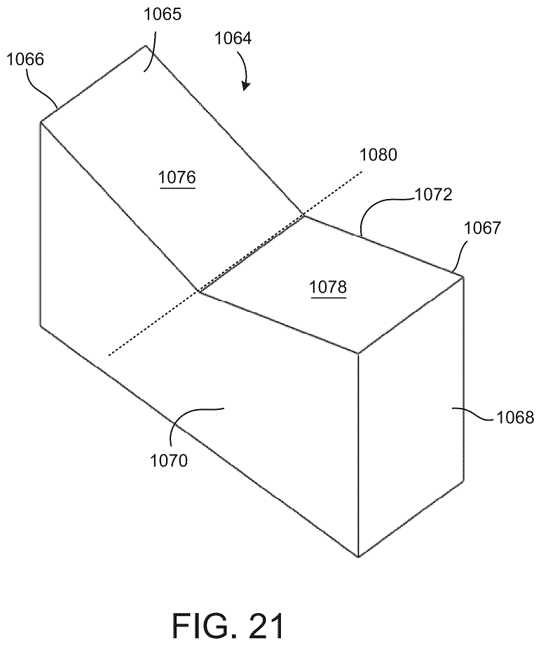

As is visible from the perspective and side views of FIGS. 21-22, the segment 1064 includes a first end 1066 and a second end 1068 opposite the first end 1066. As shown, the first end 1066 and the second end 1068 are roughly rectangular (e.g., square), but the shape can differ depending on the embodiment (e.g., curved, oblong, triangular, etc.). As shown, the first end 1066 has a surface area equal to the surface area of the second end 1068.

As shown, the segment 1064 also includes a first side 1070 and a second side 1072 opposite the first side 1070, with the first side 1070 and the second side 1072 extending from the first end 1066 to the second end 1068. The first side 1070 is perpendicular to the first end 1066 and second end 1068, and the second side 1072 is perpendicular to the first end 1066 and the second end 1068, while the first side 1070 is parallel to the second side 1072. The segment 1064 may be a substantially solid block bounded by the first side 1070, the second side 1072, the first end 1066, and the second end 1068.

The segment 1064 includes a first ramp 1076 which extends from the first end 1066 to a second ramp 1078 of the segment 1064. The first ramp 1076 is angled relative to the first end 1066 to form the first tooth 1065. The second ramp 1078 is angled relative to the second end 1068 to form the second tooth 1067. The second ramp 1078 is angled upward relative to the first ramp 1076. A surface area of the first ramp 1076 is shown as being substantially equal to the surface area of the second ramp 1078.

As illustrated in FIG. 22, the first ramp 1076 is oriented relative to a tooth base plane 1081 such that a first ramp angle 1082 is defined between the tooth base plane 1081 and the first ramp 1076 (internal to the segment 1064). The second ramp 1078 is oriented relative to the tooth base plane 1081 such that a second ramp angle 1084 is defined between the tooth base plane 1081 and the second ramp 1078 (internal to the segment 1064). As shown, ramp angles 1082, 1084 are about 20 degrees and are substantially equal to one another. Other embodiments may include different ramp angles 1082, 1084 ranging anywhere from 10 degrees to 35 degrees. Similarly, other embodiments may include ramps of different lengths which could generate different ramp angles.

The first ramp 1076 is oriented relative to the first end 1066 such that a first face angle 1086 is defined between the first ramp 1076 and the first end 1066 (internal to the segment 1064). The second ramp 1078 is oriented relative to the second end 1068 such that a second face angle 1088 is defined between the second ramp 1078 and the second end 1068 (internal to the segment 1064). The first face angle 1086 and the second face angle 1088 are acute angles up to approximately 90 degrees, and are shown as being substantially equal to one another (but may differ from one another in other embodiments). In some embodiments the first face angle 1086 and the second face angle 1088 have values between 70 degrees and 90 degrees.

In each of the embodiments described above with respect to FIGS. 1 through 23, alternate segment 206, 208, 1014, 1064 embodiments may be used together on the same saw chain 106 in a variety of patterns. For example, segment 1014 may be alternated with segment 1064 every other tie strap 202. In another example, a saw chain 106 may include pattern of the first segment 206 coupled to the tie strap 202, the segment 1016 coupled to the next tie strap 202, and the second segment 208 coupled to the next tie strap 202. In some embodiments, the segments 206, 208, 1014, 1064 may be located on the drive links 200 instead of (or in addition to) the tie straps 202. Any pattern of tie straps 202 or drive links 200 with or without segments 206, 208, 1014, 1064 may be used (e.g., skipping over every other tie strap 202, segments 206, 208, 1014, 1064 on every tie strap 202, skipping two tie straps 202 between each segment 206, 208, 1014, 1064, etc.)

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

What is claimed is:

1. A saw chain comprising:
a first tie strap;
a first drive link coupled to the first tie strap;
a second tie strap coupled to the first drive link;
a second drive link coupled to the second tie strap;
a third tie strap coupled to the second drive link;
a first contoured cutting segment coupled to the first tie strap and having a first asymmetric profile; and
a second contoured cutting segment coupled to the third tie strap and having a second asymmetric profile, wherein the first contoured cutting segment and the second contoured cutting segment are oriented such that the first asymmetric profile is symmetric with the second asymmetric profile across the second drive link.

2. The saw chain of claim 1, wherein the first contoured cutting segment comprises a first asymmetric tooth and a second asymmetric tooth.

3. The saw chain of claim 2, wherein:
the first asymmetric tooth comprises a first ramp adjacent a first face, the first ramp having a greater surface area than the first face; and
the second asymmetric tooth comprises a second ramp adjacent a second face, the second ramp having a greater surface area than the second face.

4. The saw chain of claim 3, wherein the first ramp is substantially parallel with the second ramp.

5. The saw chain of claim 3, wherein the first contoured cutting segment further comprises a third asymmetric tooth.

6. The saw chain of claim 5, wherein the third asymmetric tooth comprises a third ramp adjacent an end of the first contoured cutting segment.

7. A saw chain comprising:
a first tie strap;
a contoured cutting segment coupled to the first tie strap, the contoured cutting segment comprising:
a first asymmetric tooth; and
a second asymmetric tooth oriented such that the second asymmetric tooth is symmetric with the first asymmetric tooth across a center of the contoured cutting segment.

8. The saw chain of claim 7, wherein:
the first asymmetric tooth comprises a first ramp adjacent a first face, the first ramp having a greater surface area than the first face; and
the second asymmetric tooth comprises a second ramp adjacent a second face, the second ramp having a greater surface area than the second face.

9. The saw chain of claim 7, wherein the contoured cutting segment further comprises a third asymmetric tooth and a fourth asymmetric tooth.

10. The saw chain of claim 9, wherein the third asymmetric tooth is oriented such that the third asymmetric tooth is symmetric with the fourth asymmetric tooth across the center of the contoured cutting segment.

11. The saw chain of claim 10, wherein:
the first asymmetric tooth comprises a first ramp adjacent a first end of the contoured cutting segment;
the third asymmetric tooth comprises a second ramp adjacent a first face, the second ramp having a greater surface area than the first face;
the fourth asymmetric tooth comprises a third ramp adjacent a second face, the third ramp having a greater surface area than the second face; and
the second asymmetric tooth comprises a fourth ramp adjacent a second end of the contoured cutting segment.

12. The saw chain of claim 11, wherein:
the first ramp is substantially parallel to the second ramp; and
the third ramp is substantially parallel to the fourth ramp.

13. The saw chain of claim 7, wherein:
the first asymmetric tooth comprises a first ramp adjacent a first end of the contoured cutting segment; and
the second asymmetric tooth comprises a second ramp adjacent a second end of the contoured cutting segment.

14. A saw chain comprising:
a first tie strap;
a first drive link coupled to the first tie strap;
a second tie strap coupled to the first drive link;
a second drive link coupled to the second tie strap;
a third tie strap coupled to the second drive link;
a first contoured cutting segment coupled to the first tie strap, the first contoured cutting segment having a first plurality of asymmetric teeth; and
a second contoured cutting segment coupled to the third tie strap, the second contoured cutting segment having a second plurality of asymmetric teeth, the second plurality of asymmetric teeth symmetric with the first plurality of asymmetric teeth across the second tie strap.

15. The saw chain of claim 14, wherein:
the first plurality of asymmetric teeth comprises a first asymmetric tooth and a second asymmetric tooth; and
the second plurality of asymmetric teeth comprises a third asymmetric tooth and a fourth asymmetric tooth.

16. The saw chain of claim 15, wherein the first asymmetric tooth is oriented such that the fourth asymmetric tooth is symmetric with the first asymmetric tooth across the second tie strap and the second asymmetric tooth is oriented such that the third asymmetric tooth is symmetric with the second asymmetric tooth across the second tie strap.

17. The saw chain of claim 16, wherein:
the first asymmetric tooth comprises a first ramp adjacent a first face, the first ramp having a greater surface area than the first face;
the second asymmetric tooth comprises a second ramp adjacent a second face, the second ramp having a greater surface area than the second face;
the third asymmetric tooth comprises a third ramp adjacent a third face, the third ramp having a greater surface area than the third face; and
the fourth asymmetric tooth comprises a fourth ramp adjacent a fourth face, the fourth ramp having a greater surface area than the fourth face.

18. The saw chain of claim 17, wherein:
the first ramp is substantially parallel to the second ramp; and
the third ramp is substantially parallel to the fourth ramp.

19. The saw chain of claim 14, wherein:
the first plurality of asymmetric teeth comprises a first asymmetric tooth, a second asymmetric tooth, and a third asymmetric tooth; and
the second plurality of asymmetric teeth comprises a fourth asymmetric tooth, a fifth asymmetric tooth, and a sixth asymmetric tooth;
wherein the first asymmetric tooth is oriented such that the sixth asymmetric tooth is symmetric with the first asymmetric tooth across the second tie strap, the second asymmetric tooth is oriented such that the fifth asymmetric tooth is symmetric with the second asymmetric tooth across the second tie strap, and the third asymmetric tooth is oriented such that the fourth asymmetric tooth is symmetric with the third asymmetric tooth.

20. The saw chain of claim 19, wherein:
the first asymmetric tooth comprises a first ramp adjacent a first face, the first ramp having a greater surface area than the first face;
the second asymmetric tooth comprises a second ramp adjacent a second face, the second ramp having a greater surface area than the second face;
the third asymmetric tooth comprises a third ramp adjacent an end of the first contoured cutting segment;
the fourth asymmetric tooth comprises a fourth ramp adjacent an end of the second contoured cutting segment;
the fifth asymmetric tooth comprises a fifth ramp adjacent a third face, the fifth ramp having a greater surface area than the third face; and
the sixth asymmetric tooth comprises a sixth ramp adjacent a fourth face, the sixth ramp having a greater surface area than the fourth face.
